(19) United States
(12) Patent Application Publication
(10) Pub. No.: US 2004/0040217 A1
(43) Pub. Date: Mar. 4, 2004

(54) Polishing composition

(76) Inventors: Shigeaki Takashina, Wakayama-shi (JP); Yasuhiro Yoneda, Wakayama-shi (JP); Toshiya Hagihara, Wakayama-shi (JP)

Correspondence Address: BIRCH STEWART KOLASCH & BIRCH, PO BOX 747, FALLS CHURCH, VA, 22040-0747, US

(21) Appl. No.: 10/637,568

(22) Filed: Aug. 11, 2003

(30) Foreign Application Priority Data
Aug. 28, 2002 (JP) 2002-248857

(51) Int. Cl. C09G 1/02; C09G 1/04

(52) U.S. Cl. 51/307; 51/308; 51/309; 106/3; 438/692; 438/693

(57) ABSTRACT

A polishing composition comprising an aqueous medium and abrasive particles, wherein the abrasive particles comprise abrasive particles having a particle size of 2 to 200 nm in an amount of 50% by volume or more, the abrasive particles having a particle size of 2 to 200 nm comprising (i) 40 to 75% by volume of small size particles having a particle size of 2 nm or more and less than 58 nm; (ii) 0 to 50% by volume of intermediate size particles having a particle size of 58 nm or more and less than 75 nm; and (iii) 10 to 60% by volume of large size particles having a particle size of 75 nm or more and 200 nm or less; a polishing composition comprising an aqueous medium and abrasive particles, wherein the abrasive particles comprise abrasive particles (A) having an average particle size of 2 to 50 nm; and abrasive particles (B) having an average particle size of 52 to 200 nm, wherein a weight ratio of A to B (A/B) is from 0.5/1 to 4.5/1; a polishing process comprising subjecting a semiconductor substrate to planarization with the polishing composition; a method for planarization of a semiconductor substrate with the polishing composition; and a method for manufacturing a semiconductor device, comprising polishing a semiconductor substrate with the polishing composition. The polishing composition can be favorably used in polishing the substrate for a semiconductor device, and the method for manufacturing a semiconductor device can be favorably used for manufacturing a semiconductor device such as memory ICs, logic ICs and system LSIs.

### BACKGROUND OF THE INVENTION

1. Field of the Invention

The present invention relates to a polishing composition, a polishing process with the polishing composition, a method for planarization of a semiconductor substrate, and a method for manufacturing a semiconductor device. More specifically, the present invention relates to a polishing composition useful in planarization of a semiconductor substrate having a thin film formed on its rugged surface, a polishing process comprising subjecting a semiconductor substrate to planarization with the polishing composition, a method for planarization of a semiconductor substrate with the polishing composition, and a method for manufacturing a semiconductor device, comprising polishing a semiconductor substrate with the polishing composition.

2. Discussion of the Related Art

In an ultra large scale integrated circuit of the present day, there is a tendency that a transistor and other semiconductor elements are reduced in size, thereby increasing mounting density. Therefore, various microfibrication techniques have been developed. One of the microfabrication techniques includes chemical-mechanical polishing (also simply referred to as “CMP”) technique. The CMP technique is very important in the process for manufacturing a semiconductor device, for instance, shallow trench isolation (STI), planarization of interlayer dielectric, formation of embedded metal line, plug formation, formation of embedded capacitor, and the like. Among them, the planarization, which serves to reduce a step height of the polishing surface, which is carried out when various metals, dielectrics and the like are laminated, is an important step from the viewpoints of miniaturization and densification of a semiconductor device. Therefore, there has been desired to quickly realize planarization.

One example of a polishing liquid for CMP usable in the above production steps includes a dispersion of abrasive particles in water. The abrasive particles include particles of fumed silica, alumina and the like. Among them, the fumed silica is widely used because of its low cost and high purity. However, there is a disadvantage in the fumed silica that scratches are likely to be generated on the surface because aggregated particles (secondary particles) are formed in the production process. On the other hand, since silica abrasive grains which are referred to as “colloidal silica” have relatively spherical surface shape, and are in a state of nearly monodisperse, aggregated particles are hardly likely to be formed, so that reduction in scratches can be expected and that the silica abrasive grains have begun to be used. However, there is a disadvantage in the silica abrasive grains that the polishing rate is generally low.

As to a polishing composition using the colloidal silica, Japanese Patent Laid-Open No. 2001-323254 discloses a silica polishing liquid having a specified particle size distribution. However, the main feature of the polishing liquid is to reduce a surface roughness of a surface to be polished from 5 to 15 Å or so (0.5 to 1.5 nm or so) to 3 Å or less (0.3 nm or less). When the silica has the specified particle size distribution, it would take much time for planarization of a step height of the surface of a semiconductor substrate of 100 to 20000 Å (10 to 2000 nm).

Also, Japanese Patent Laid-Open No. 2002-30274 discloses that a polished surface having small average waviness (several Å or less) is obtained by using the polishing composition comprising a mixture of two kinds of colloidal silicas having different particle sizes. The problem of obtaining the polished surface having small average waviness (several Å or less) is, for instance, a problem for reducing an average waviness of a polished surface in which an average waviness of an initial surface to be polished caused in the final polishing process of a hard disk is several dozen Å or less), and an average waviness of the polished surface is several Å or less). Therefore, the polished surface having an average waviness of several Å or less concretely disclosed in the publication is concerned with a surface after final polishing of a hard disk, which is essentially different from a surface to be polished having step height subjected to planarization, for instance, a surface of a semiconductor substrate or the like.

Further, U.S. Pat. No. 6,143,662 discloses a CMP method using a slurry comprising small size particles having an average particle size of 2 to 30 nm and large size particles having an average particle size of 2 to 10 times that of the small size particles, wherein the volume ratio of the small size particles to the large size particles is 5:1 to 100:1. However, there are some disadvantages that since the small size particles occupy the majority of 83% or more of the slurry, the polishing rate is low and the polishing time required up to completion of planarization becomes longer, so that it is unsatisfactory from the viewpoint of planarization efficiency.

### SUMMARY OF THE INVENTION

According to the present invention, there are provided:

[1] a polishing composition comprising an aqueous medium and abrasive particles, wherein the abrasive particles comprise abrasive particles having a particle size of 2 to 200 nm in an amount of 50% by volume or more, the abrasive particles having a particle size of 2 to 200 nm comprising:

(i) 40 to 75% by volume of small size particles having a particle size of 2 nm or more and less than 58 nm;

(ii) 0 to 50% by volume of intermediate size particles having a particle size of 58 nm or more and less than 75 nm; and

(iii) 10 to 60% by volume of large size particles having a particle size of 75 nm or more and 200 nm or less;

[2] a polishing composition comprising an aqueous medium and abrasive particles, wherein the abrasive particles comprise:

abrasive particles (A) having an average particle size of 2 to 50 nm; and

abrasive particles (B) having an average particle size of 52 to 200 nm,

wherein a weight ratio of A to B (A/B) is from 0.5/1 to 4.5/1;

[3] a polishing process comprising subjecting a semiconductor substrate to planarization with the polishing composition as defined in the above [1];

[4] a polishing process comprising subjecting a semiconductor substrate to planarization with the polishing composition as defined in the above [2];

[5] a method for planarization of a semiconductor substrate with the polishing composition as defined in the above [1];

[6] a method for planarization of a semiconductor substrate with the polishing composition as defined in the above [2];

[7] a method for manufacturing a semiconductor device, comprising polishing a semiconductor substrate with the polishing composition of as defined in the above [1]; and

[8] a method for manufacturing a semiconductor device, comprising polishing a semiconductor substrate with the polishing composition of as defined in the above [2].

### DETAILED DESCRIPTION OF THE INVENTION

The present invention relates to a polishing composition capable of subjecting a semiconductor substrate having a step height to be polished to planarization in a short period of time; a polishing process comprising subjecting a semiconductor substrate to planarization with step height to be polished with the polishing composition; a method for subjecting a semiconductor substrate to planarization; and a method for manufacturing a semiconductor device, comprising polishing a semiconductor substrate with the polishing composition.

These and other advantages of the present invention will be apparent from the following description.

As mentioned above, the polishing composition of the present invention includes two embodiments:

(Embodiment 1) a polishing composition comprising an aqueous medium and abrasive particles, wherein the abrasive particles comprise abrasive particles having a particle size of 2 to 200 nm in an amount of 50% by volume or more, the abrasive particles having a particle size of 2 to 200 nm comprising:

(i) 40 to 75% by volume of small size particles having a particle size of 2 nm or more and less than 58 nm;

(ii) 0 to 50% by volume of intermediate size particles having a particle size of 58 nm or more and less than 75 nm; and

(iii) 10 to 60% by volume of large size particles having a particle size of 75 nm or more and 200 nm or less; and

(Embodiment 2) a polishing composition comprising an aqueous medium and abrasive particles, wherein the abrasive particles comprise:

abrasive particles (A) having an average particle size of 2 to 50 nm; and

abrasive particles (B) having an average particle size of 52 to 200 nm,

wherein a weight ratio of A to B (A/B) is from 0.5/1 to 4.5/1.

In Embodiments 1 and 2, the above-mentioned abrasive particles include, for instance, inorganic particles, including particles of metals, carbides of metals or metalloids, nitrides of metals or metalloids, oxides of metals or metalloids, borides of metals or metalloids, diamond, and the like. The elements for metals or metalloids include those elements belonging to the Groups 3A, 4A, 5A, 3B, 4B, 5B, 6B, 7B or 8B of the Periodic Table. Examples of the inorganic particles include particles of silicon dioxide, aluminum oxide, cerium oxide, titanium oxide, zirconium oxide, silicon nitride, manganese dioxide, silicon carbide, zinc oxide, diamond and magnesium oxide.

Among these inorganic particles, those particles of silicon dioxide, aluminum oxide and cerium oxide are preferable, and silicon dioxide is more preferable from the viewpoint of reducing scratches. Concrete examples include silicon dioxide particles such as colloidal silica particles, fumed silica particles and surface-modified silica particles; aluminum oxide particles such as α-alumina particles, γ-alumina particles, δ-alumina particles, θ-alumina particles, η-alumina particles, amorphous alumina particles, other fumed alumina particles and colloidal alumina particles prepared by different processes; cerium oxide particles such as those having an oxidation number of 3 or 4 and those having hexagonal, isometric or face-centered cubic crystal system; and the like.

Further, among these inorganic particles, colloidal silica particles are more preferable. The colloidal silica particles have a relatively spherical shape, which can be stably dispersed in the state of primary particles, so that aggregated particles are hardly formed, whereby scratches on a surface to be polished can be reduced. The colloidal silica particles can be prepared by a sodium silicate method using an alkali metal silicate such as sodium silicate as a raw material, or an alkoxysilane method using tetraethoxysilane or the like as a raw material. These abrasive particles may be used alone or in admixture of two or more kinds.

The abrasive particles used in Embodiment 1 comprise abrasive particles having a particle size of 2 to 200 nm in an amount of 50% by volume or more. The content of the above-mentioned abrasive particles having a particle size of 2 to 200 nm is preferably 70% by volume or more, more preferably 85% by volume or more, especially preferably 95% by volume or more, most preferably 100% by volume, from the viewpoints of planarization property and reduction in scratches.

In Embodiment 1, the above-mentioned abrasive particles having a particle size of 2 to 200 nm comprise 40 to 75% by volume of small size particles having a particle size of 2 nm or more and less than 58 nm; 0 to 50% by volume of intermediate size particles having a particle size of 58 nm or more and less than 75 nm; and 10 to 60% by volume of large size particles having a particle size of 75 nm or more and 200 nm or less.

The content of the above-mentioned small size particles is preferably from 42 to 73% by volume, more preferably from 43 to 72% by volume, from the viewpoint of planarization property. The content of the intermediate size particles is preferably from 0 to 40% by volume, more preferably from 0 to 30% by volume, especially preferably from 0 to 25% by volume, from the viewpoint of planarization property. The content of the large size particles is preferably from 13 to 55% by volume, more preferably from 15 to 50% by volume, from the viewpoint of planarization property.

The particle size distribution of the above-mentioned abrasive particles can be determined by the method described below. Specifically, the photographs of the abrasive particles observed by a transmission electron microscope “JEM-2000 FX” commercially available from JEOL LTD. (80 kV, magnification: 10000 to 50000) are incorporated into a personal computer as image data with a scanner connected thereto. The equivalent diameter of each abrasive particle is determined using an analysis software “WinROOF” (commercially available from MITANI CORPORATION), and considered as the diameter of abrasive particle. After analyzing data for 1000 or more abrasive particles, the volume of abrasive particles are calculated from the diameters of the abrasive particles based on the analyzed data using a spreadsheet software “EXCEL” (commercially available from Microsoft Corporation). First, the ratio (based on % by volume) of abrasive particles of 2 nm or more and 200 nm or less (2 to 200 nm) to the entire abrasive particles is calculated. Further, the ratio of the particles in each of the three ranges, 2 nm or more and less than 58 nm, 58 nm or more and less than 75 nm, and 75 nm or more and 200 nm or less (75 to 200 nm), to the total abrasive particles of 2 nm or more and 200 nm or less.

It is preferable that the abrasive particles used in Embodiment 2 comprise at least 50% by weight, more preferably 70% by weight or more, still more preferably 85% by weight or more, especially preferably 95% by weight or more, most preferably 100% by weight of the total of the above-mentioned abrasive particles (A) and the above-mentioned abrasive particles (B), from the viewpoints of planarization property and reduction in scratches.

Of the abrasive particles used in Embodiment 2, the abrasive particles mixed as the abrasive particles (A) have an average particle size of from 2 to 50 nm, preferably from 10 to 50 nm, especially preferably from 26 to 50 nm, from the viewpoint of increasing the polishing rate. Also, the abrasive particles mixed as the abrasive particles (B) have an average particle size of 52 nm or more and 200 nm or less, preferably 55 nm or more and 170 nm or less, from the viewpoint of preventing precipitation and separation of the particles.

In Embodiment 2, it is preferable that the ratio of average particle sizes (Dmax/Dmin) is more than 3, wherein Dmax is an average particle size of the abrasive particles having the largest average particle size which are mixed as the abrasive particles (B), and Dmin is an average particle size of the abrasive particles having the smallest average particle size which are mixed as the abrasive particles (A), from the viewpoint of planarization property. Here, the average particle size D (nm) can be calculated by D=2720/S, wherein S (m²/g) is a specific surface area determined by nitrogen adsorption method.

In Embodiment 2, the weight ratio of the abrasive particles (A) to the abrasive particles (B), i.e. A/B, is from 0.5/1 to 4.5/1, preferably from 1.0/1 to 4.0/1, from the viewpoint of planarization property for the lower limit and from the viewpoint of polishing rate for the upper limit. The abrasive particles that can be mixed as the abrasive particles (A) and the abrasive particles (B) can be used in admixture of one of more kinds, as long as the particles have an average particle size within the ranges as defined above.

In addition, as the abrasive particles usable in the present invention, from the viewpoint of efficient polishing with reducing scratches and planarization in a short period of time, there can be used those satisfying both the requirements for the abrasive particles used in Embodiments 1 and 2, i.e. the abrasive particles comprising abrasive particles having a particle size of 2 to 200 nm in an amount of 50% by volume or more, the abrasive particles having a particle size of 2 to 200 nm comprising (i) 40 to 75% by volume of small size particles having a particle size of 2 nm or more and less than 58 nm; (ii) 0 to 50% by volume of intermediate size particles having a particle size of 58 nm or more and less than 75 nm; and (iii) 10 to 60% by volume of large size particles having a particle size of 75 nm or more and 200 nm or less, and the abrasive particles comprising abrasive particles (A) having an average particle size of 2 to 50 nm, and abrasive particles (B) having an average particle size of 52 to 200 nm, wherein a weight ratio of A to B (A/B) is from 0.5/1 to 4.5/1.

In Embodiments 1 and 2, the abrasive particles are contained in the polishing composition in an amount of preferably from 1 to 50% by weight, more preferably from 3 to 40% by weight, especially preferably from 5 to 30% by weight, from the viewpoint of polishing rate for the lower limit and from the viewpoints of dispersion stability and cost for the upper limit.

In Embodiments 1 and 2, the aqueous medium includes water, and a mixed medium of water and a water-miscible solvent such as an alcohol. However, it is preferable to use water. The amount of the aqueous medium in the polishing composition is preferably from 40 to 99% by weight, more preferably from 50 to 97% by weight, especially preferably from 60 to 95% by weight, from the viewpoint of dispersion stability for the lower limit and from the viewpoint of polishing rate for the upper limit.

The polishing compositions of Embodiments 1 and 2 comprise the above-mentioned aqueous medium and abrasive particles. The polishing composition comprising the abrasive particles can be prepared, for instance, by the following methods: a method comprising formulating the abrasive particles in an aqueous medium, further pulverizing the abrasive particles as occasion demands in the case of, for instance, powdery abrasive particles, and forcibly dispersing the abrasive particles by a mechanical force such as ultrasonication, agitation or kneading; and a method comprising allowing inorganic particles to grow in an aqueous medium. Among them, the method comprising allowing inorganic particles to grow in an aqueous medium is preferable because the resulting inorganic particles are stably dispersed and the control of the particle size is facilitated.

The polishing compositions of Embodiments 1 and 2 can optionally contain various additives. The additives include a pH adjusting agent, a dispersion stabilizer, an oxidizing agent, a chelating agent, a preservative, and the like.

The pH adjusting agent includes basic substances such as an aqueous ammonia, potassium hydroxide, sodium hydroxide and water-soluble organic amines, and acidic substances including organic acids such as acetic acid, oxalic acid, succinic acid, glycolic acid, malic acid, citric acid and benzoic acid, and inorganic acids such as nitric acid, hydrochloric acid, sulfuric acid and phosphoric acid. Here, oxalic acid and succinic acid can be also used as a chelating agent.

The dispersion stabilizer includes surfactants such as anionic surfactants, cationic surfactants and nonionic surfactants, polymeric dispersants such as polyacrylic acids or salts thereof, acrylate copolymers and ethylene oxide/propylene oxide block copolymers (Pluronics), and the like.

The oxidizing agent includes peroxides, permanganic acid or salts thereof, chromic acid or salts thereof, nitric acid or salts thereof, peroxo acid or salts thereof, oxyacid or salts thereof, metal salts, sulfuric acid, and the like.

The chelating agent includes polycarboxylic acids such as oxalic acid, succinic acid, phthalic acid and trimellitic acid; hydroxycarboxylic acids such as glycolic acid, malic acid, citric acid and salicylic acid; polyaminocarboxylic acids such as nitrilotriacetic acid and ethylenediaminetetraacetic acid; phosphonic acids such as aminotri(methylenephosphonic acid) and 1-hydroxyethylidene-1,1-diphosphonic acid, and the like.

The preservative includes benzalkonium chloride, benzethonium chloride, 1,2-benzisothiazolin-3-one, and the like.

It is preferable that the pH of the polishing compositions of Embodiments 1 and 2 is appropriately determined depending upon the kinds of the objects to be polished and the required properties. For instance, it is preferable that the pH of the polishing composition is preferably from 2 to 12, from the viewpoints of the cleanability of the objects to be polished, the anti-corrosiveness of the working machine, and the safety of the operator. In addition, when the objects to be polished are used for polishing a semiconductor wafer, a semiconductor element, or the like, especially for polishing a silicon substrate, a poly-silicon substrate, a silicon oxide film, or the like, the pH is more preferably from 7 to 12, still more preferably from 8 to 12, especially preferably from 9 to 12, from the viewpoints of increasing the polishing rate and improving the surface qualities. The pH can be adjusted by adding the above-mentioned pH adjusting agent properly in a desired amount as occasion demands.

The polishing process of the present invention refers to a process comprising polishing a surface to be polished by using the polishing composition of Embodiment 1 or 2, or a polishing liquid prepared by mixing each component so as to give the composition of the polishing composition of Embodiment 1 or 2, whereby the substrate for precision parts, such as a semiconductor substrate can be especially suitably produced. Therefore, the present invention relates to a method for manufacturing a semiconductor device.

The material for objects to be polished which are the subjects of the present invention includes, for instance, metals or metalloids such as silicon, aluminum, nickel, tungsten, copper, tantalum and titanium; alloys made of these metals as main components; glassy substances such as glass, glassy carbon and amorphous carbons; ceramic materials such as alumina, silicon dioxide, silicon nitride, tantalum nitride, titanium nitride and polysilicon; resins such as polyimide resins; and the like. Especially, in a case where the polishing composition of Embodiment 1 or 2 (hereinafter referred to as the polishing composition of the present invention) is used when polishing a substrate having silicon dioxide film formed on the surface to be polished such as a glass and PE-TEOS (Plasma Enhanced-Tetraethoxysilane) substrate, or a substrate having a polysilicon, the efficient polishing can be carried out.

The shape for these objects to be polished is not particularly limited. For instance, those having shapes containing planar portions such as disks, plates, slabs and prisms, or shapes containing curved portions such as lenses can be subjects for polishing with the polishing composition of the present invention. Among them, those having the disk-shaped objects to be polished are preferable in polishing, and especially preferable in polishing for the purpose of subjecting a semiconductor substrate with step height to planarization. Therefore, the present invention relates to a method for subjecting a semiconductor substrate to planarization.

In the rugged surface to be polished in the present invention, the step height is preferably from 100 to 20000 Å (from 10 to 2000 nm), more preferably from 1000 to 15000 Å (from 100 to 1500 nm). Here, the step height can be determined using a profiler (for instance, HRP-100 commercially available from KLA-Tencor).

The polishing of the semiconductor substrates comprises the steps of polishing a silicon wafer (bare wafer), forming a film for STI, subjecting an interlayer dielectric to planarization, forming an embedded metal line, and forming embedded capacitor, and the like. The polishing composition of the present invention is especially suitable for forming a film for STI, and subjecting an interlayer dielectric to planarization.

The polishing process using the polishing composition of the present invention is not particularly limited, and general methods can be used. Among them, a process using a polishing device comprising a jig for supporting an object to be polished and an abrasive cloth is preferred. The polishing process includes a process of polishing a surface of an object to be polished by pressing the above-mentioned jig for supporting the object to be polished against an abrasive disk attached to an abrasive cloth such as an organic polymer-based foamed article, a non-foamed article, or a nonwoven fabric, or clamping the above-mentioned object to be polished with an abrasive disk attached to an abrasive cloth; feeding the polishing composition of the present invention to the surface of the object to be polished; and moving the abrasive disk or the object to be polished, with applying a given pressure.

In addition, the method for manufacturing a semiconductor device of the present invention comprises the steps of forming a thin film on an upper part of a semiconductor substrate with a step height, and polishing the thin film, wherein the polishing composition of the present invention, comprising an aqueous medium and abrasive particles is fed to the thin film surface in the above-mentioned polishing step, thereby subjecting the thin film with a step height to planarization by the CMP. The method for manufacturing a semiconductor device of the present invention is suitably used for manufacturing a semiconductor device such as memory ICs, logic ICs and system LSIs.

As described above, the efficient planarization can be carried out by using the polishing composition of the present invention, the polishing process using the polishing composition, and the method for manufacturing a semiconductor device comprising polishing a semiconductor substrate with the polishing composition.

### EXAMPLES

### Examples 1 to 5 and Comparative Examples 1 to 4

As the abrasive particles, silica particles as shown in Table 1 were used.

TABLE 1

| | | | | Average |
|---|---|---|---|---|
| Abrasive | Kind of | | | Particle |
| Particles | Particles | Trade Name | Manufacturer | Size |
| (A) | | | | |
| Abrasive Particles 1 | Colloidal Silica | Cataloid SI-30 | CATALYSTS & CHEMICALS | 11 nm |
| | | | INDUSTRIES CO., LTD. | |
| Abrasive Particles 2 | Colloidal Silica | Cataloid SI-40 | CATALYSTS & CHEMICALS | 18 nm |
| | | | INDUSTRIES CO., LTD. | |
| Abrasive Particles 3 | Colloidal Silica | Cataloid SI-50 | CATALYSTS & CHEMICALS | 26 nm |
| | | | INDUSTRIES CO., LTD. | |
| Abrasive Particles 4 | Colloidal Silica | Cataloid SI-45P | CATALYSTS & CHEMICALS | 45 nm |
| | | | INDUSTRIES CO., LTD. | |
| (B) | | | | |
| Abrasive Particles 5 | Colloidal Silica | Experimental Product | CATALYSTS & CHEMICALS | 58 nm |
| | | | INDUSTRIES CO., LTD. | |
| Abrasive Particles 6 | Colloidal Silica | Cataloid SI-80P | CATALYSTS & CHEMICALS | 80 nm |
| | | | INDUSTRIES CO., LTD. | |
| Abrasive Particles 7 | Colloidal Silica | Levasil 50CK-30% | Bayer Ltd. | 85 nm |
| Abrasive Particles 8 | Colloidal Silica | Spherica Slurry 120 | CATALYSTS & CHEMICALS | 120 nm |
| | | | INDUSTRIES CO., LTD. | |
| Abrasive Particles 9 | Colloidal Silica | Spherica Slurry 160 | CATALYSTS & CHEMICALS | 160 nm |
| | | | INDUSTRIES CO., LTD. | |

In order to obtain the polishing composition of the present invention, a polishing composition having a concentration of abrasive particles (balance: water) as shown in Table 2 or 3 using the silica particles as shown in Table 1 and water was prepared. In addition, the pH of the polishing composition was adjusted with an aqueous potassium hydroxide so as to have a pH of 10.5 to 11.5. The concentration of abrasive particles shown in Table 2 was determined so that the polishing rate was about 2300 (Å/min) [230 nm/min] according to the following conditions for polishing device and determination method for polishing rate.

<Conditions for Polishing Device>

Polishing testing machine: LP-541 (platen diameter: 540 mm), commercially available from Lap Master SFT

Polishing pad: IC-1000/Suba 400 (commercially available from Rodel Nitta Company).

Platen rotational speed: 60 r/min

Carrier rotational speed: 58 r/min

Flow rate of polishing composition: 200 (g/min)

Polishing load: 300 (g/cm²)

<Determination Method for Polishing Rate>

Using each of the polishing compositions, an 8-inch (a 200-mm) silicon substrate having a 2 μm-PE-TEOS film formed thereon, which was used as an object to be polished was polished under the set conditions mentioned above for 2 minutes. The polishing rate (nm/min) was determined from the difference between the thickness of the film before polishing and that of the remaining film after polishing. The thickness of the remaining film was determined using a light interference-type film thickness gauge (VM-1000, commercially available from DAINIPPON SCREEN MFG. CO., LTD.).

In order to evaluate the planarization property, the evaluation was made on the basis of time needed for removing the step height previously formed on the wafer by polishing with a commercially available wafer for evaluating CMP properties (trade name: SKW 7-2, commercially available from SKW Associates, Inc., difference in ruggedness: 8000 Å (800 nm)) as an object to be polished. Specifically, the thicknesses of the remaining film of line portion and space portion of the GRADUAL D90 patterns on the wafer were determined for every minute of polishing under the above-mentioned set conditions (the determination method was the same as above). The polishing was repeated until the amount of the step height became 0 (planarization being completed), which can be found from the initial difference which was already known, and the polishing time required was determined. The results are expressed by the polishing time required to complete the planarization, and those polishing compositions having a polishing time of 4 minutes or less are considered to be excellent in planarization (Table 2). It can be seen from the above that the planarization property in Examples 1 to 5 are excellent, as compared to Comparative Examples 1 to 4, regardless of the polishing rate of all of the polishing compositions of which was set at 230 nm/min.

TABLE 2

| | Abrasive Particles of Table 1 and | | | | | | | | | | Concentration | |
|---|---|---|---|---|---|---|---|---|---|---|---|---|
| | Compositional Ratio (% by weight) | | | | | | | | | Weight | of Abrasive | Planarization |
| | Abrasive Particles (A) | | | | Abrasive Particles (B) | | | | | Ratio | Particles | Time |
| | 1 | 2 | 3 | 4 | 5 | 6 | 7 | 8 | 9 | (A/B) | (% by weight) | (min) |
| Ex. 1 | | 70 | | | | 30 | | | | 2.3/1 | 24 | 4 |
| Ex. 2 | | 70 | | | 30 | | | | | 2.3/1 | 22 | 4 |
| Ex. 3 | | | | 77 | | 15 | | | 8 | 3.5/1 | 17 | 4 |
| Ex. 4 | | 23 | | 32 | | 45 | | | | 1.2/1 | 22 | 4 |
| Ex. 5 | 5 | 10 | 15 | 35 | | 20 | | 10 | 5 | 1.9/1 | 20 | 4 |

Comparative Examples

| | | | | | | |
|---|---|---|---|---|---|---|
| Comp. | | 100 | | only A | 20 | 5 |
| Ex. 1 | | | | | | |
| Comp. | 35 | 65 | | only A | 25 | 5 |
| Ex. 2 | | | | | | |
| Comp. | | | 100 | only B | 13 | 6 or more |
| Ex. 3 | | | | | | |
| Comp. | 90 | 10 | | only A | 30 | 5 |
| Ex. 4 | | | | | | |

TABLE 3

| | | % by Volume to Entire Abrasive | | |
|---|---|---|---|---|
| | | Particles Having Particle Size | | |
| | Content of Abrasive Parti- | of 2 to 200 nm | | |
| | cles Having Particle Size of | 2 nm or | 58 nm or | 75 nm or |
| | 2-200 nm in Entire | more and | more and | more and |
| | Abrasive Particles | less than | less than | 200 nm |
| | (% by volume) | 58 nm | 75 nm | or less |
| Ex. 1 | 100 | 70.0 | 0.0 | 30.0 |
| Ex. 2 | 100 | 70.0 | 9.4 | 20.6 |
| Ex. 3 | 100 | 56.7 | 20.3 | 23.0 |
| Ex. 4 | 100 | 46.6 | 8.4 | 45.0 |
| Ex. 5 | 100 | 55.8 | 9.2 | 35.0 |
| Comp. | 100 | 73.7 | 26.3 | 0.0 |
| Ex. 1 | | | | |
| Comp. | 100 | 82.9 | 17.1 | 0.0 |
| Ex. 2 | | | | |
| Comp. | 100 | 3.5 | 11.8 | 84.7 |
| Ex. 3 | | | | |
| Comp. | 100 | 97.4 | 2.6 | 0.0 |
| Ex. 4 | | | | |

The polishing composition of the present invention can realize efficient planarization of a rugged surface to be polished. Accordingly, by using the polishing composition of the present invention, there can be provided a polishing process and a method for manufacturing a semiconductor device comprising polishing a semiconductor substrate with the polishing composition.

What is claimed is:

1. A polishing composition comprising an aqueous medium and abrasive particles, wherein the abrasive particles comprise abrasive particles having a particle size of 2 to 200 nm in an amount of 50% by volume or more, the abrasive particles having a particle size of 2 to 200 nm comprising:
(i) 40 to 75% by volume of small size particles having a particle size of 2 nm or more and less than 58 nm;
(ii) 0 to 50% by volume of intermediate size particles having a particle size of 58 nm or more and less than 75 nm; and
(iii) 10 to 60% by volume of large size particles having a particle size of 75 nm or more and 200 nm or less.

2. A polishing composition comprising an aqueous medium and abrasive particles, wherein the abrasive particles comprise:
abrasive particles (A) having an average particle size of 2 to 50 nm; and
abrasive particles (B) having an average particle size of 52 to 200 nm,
wherein a weight ratio of A to B (A/B) is from 0.5/1 to 4.5/1.

3. The polishing composition according to claim 1, wherein a surface to be polished is a surface of a semiconductor substrate.

4. The polishing composition according to claim 2, wherein a surface to be polished is a surface of a semiconductor substrate.

5. The polishing composition according to claim 1 or 3, wherein the abrasive particles are made of silicon dioxide.

6. The polishing composition according to claim 2 or 4, wherein the abrasive particles are made of silicon dioxide.

7. A polishing process comprising subjecting a semiconductor substrate to planarization with the polishing composition as defined in claim 1 or 3.

8. A polishing process comprising subjecting a semiconductor substrate to planarization with the polishing composition as defined in claim 2 or 4.

9. A method for planarization of a semiconductor substrate with the polishing composition as defined in claim 1 or 3.

10. A method for planarization of a semiconductor substrate with the polishing composition as defined in claim 2 or 4.

11. A method for manufacturing a semiconductor device, comprising polishing a semiconductor substrate with the polishing composition of as defined in claim 1 or 3.

12. A method for manufacturing a semiconductor device, comprising polishing a semiconductor substrate with the polishing composition of as defined in claim 2 or 4.
